(19) United States
(12) Patent Application Publication
(10) Pub. No.: US 2011/0026924 A1
(43) Pub. Date: Feb. 3, 2011

(54) OFDM OPTICAL TRANSMITTER AND OPTICAL TRANSMISSION METHOD

(75) Inventors: Hwan-Seok Chung, Daejeon-si (KR); Sun-Hyok Chang, Daejeon-si (KR); Kwang-Joon Kim, Daejeon-si (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/821,465

(22) Filed: Jun. 23, 2010

(30) Foreign Application Priority Data
Aug. 3, 2009 (KR) 10-2009-0071433

(51) Int. Cl. H04J 14/02; H04B 10/04

(52) U.S. Cl. 398/79; 398/183

(57) ABSTRACT

An OFDM optical transmitter and optical transmission method is provided. The OFDM optical transmitter includes a signal converter controlling amplitude of each of data signals according to a position of each of the data signals and converting the controlled data signal into a time-domain signal. Accordingly, it is possible to generate optical OFDM carriers which are uniform in size.

### CROSS-REFERENCE TO RELATED APPLICATION

This application claims the benefit under 35 U.S.C. §119(a) of Korean Patent Application No. 10-2009-0071433, filed on Aug. 3, 2009, the entire disclosure of which is incorporated herein by reference for all purposes.

### BACKGROUND

1. Field

The following description relates to an optical transmitter and optical transmission method for high-rate data transmission and, more particularly, to an orthogonal frequency-division multiplexing (OFDM) optical transmitter and optical transmission method.

2. Description of the Related Art

With the development of IP-based services, especially Internet television or user-created content (UCC), network traffic increases and a high bandwidth network is thus increasingly required in recent years. An optical transmission system employing wavelength-division multiplexing (WDM), which is a technology of multiplexing multiple optical carrier signals on a single optical fiber by using different wavelengths of light to carry different signals, is increasingly popular as a means to efficiently process increased traffic. The efficient transmission of the increased traffic requires a high transmission rate per channel and a variety of modulation schemes focusing on high-rate channels.

On the other hand, signals with 40G or more per wavelength have been introduced to provide bandwidths required by entities, such as high-performance computing servers, data sensors, enterprise networks, and Internet exchange centers, which handle high data traffic. To transmit such high-rate signals, an optical transmitter employs phase-shift keying (PSK), which conveys data by modulating the phase of an optical signal, or quadrature phase-shift keying (QPSK), which can encode two bits per symbol. The PSK or QPSK modulation scheme is advantageous in overcoming limitations of optical/electrical components in a high-rate optical transmission system and in suppressing restrictions on an optical fiber.

A PSK or QPSK signal is typically transmitted over a single carrier. Hence, as the transmission rate increases, chromatic dispersion and polarization mode dispersion which occur on an optical fiber need to be compensated channel by channel at a receiving node. To solve this problem, an orthogonal frequency-division multiplexing (OFDM) optical transmitter has been proposed which divides a high-rate signal into a plurality of low-rate signals and transmits the low-rate signals over a plurality of carriers. The OFDM optical transmitter converts high-rate data bits of a data signal received in series into low-rate parallel data bits, inserts symbols and converts the resultant digital signal into a time-domain signal. Further, a digital-to-analog converter (DAC) converts the digital data signal to the time-domain analog signal. The OFDM optical transmitter then performs optical modulation on the analog signal.

As the sampling rate upon digital to analog conversion becomes increasingly higher than the rate of a signal which is input to a digital-to-analog converter (DAC), a difference in amplitude of generated optical carriers becomes smaller. In the case of an optical OFDM scheme, zo however, if an optical signal is transmitted at a rate of 10 Gb/s or greater, it is difficult to make the sampling rate of the DAC faster than the rate of the signal. Hence, a generated optical subcarrier after optical modulation operation is gradually decreased in amplitude as the optical subcarrier becomes increasingly distant from the optical carrier. As a result, a signal distant from the optical carrier may have a poor bit error rate (BER) at the same signal-to-noise ratio (SNR), resulting in a poor high-rate signal transmission quality.

### SUMMARY

The following description relates to an orthogonal frequency-division multiplexing (OFDM) optical transmitter and optical transmission method, capable of ensuring signal-to-noise ratio (SNR) between optical OFDM carriers by controlling amplitude of each of data signals according to a position of each data signal prior to performing digital-to-analog conversion operation so as to output the OFDM carriers with a uniform size although the sampling rate of the data signal is not significantly higher than the input rate of the data signal when the data signal is converted into an analog signal.

In one general aspect, there is provided an optical transmitter in an OFDM-based communication system, including a signal converter controlling amplitude of each of data signals according to a position of each of the data signals and converting the controlled data signal into a time-domain signal.

In another general aspect, there is provided an optical transmission method of an OFDM-based communication system, including: controlling amplitude of each of data signals according to a position of each of the data signals; and converting the amplitude-controlled data signal into a time-domain signal.

Other features and aspects will be apparent from the following detailed description, the drawings, and the claims.

### BRIEF DESCRIPTION OF THE DRAWINGS

FIG. 1 is a block diagram illustrating an example of an OFDM optical transmitter according to an exemplary embodiment of the present invention.

FIG. 2 is a graph illustrating the amplitude of a data signal controlled by a signal converter according to an exemplary embodiment of the present invention.

FIG. 3 is a flowchart illustrating an optical transmission method in an OFDM optical transmitter according to an exemplary embodiment of the present invention.

FIG. 4 is a diagram illustrating signals of an OFDM optical transmitter at each stage in FIG. 3.

Throughout the drawings and the detailed description, unless otherwise described, the same reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

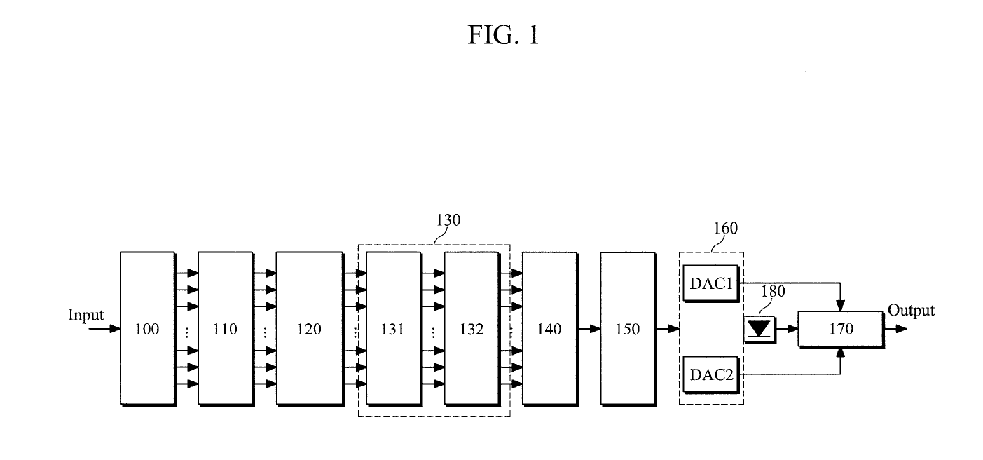

FIG. 1 is a block diagram illustrating an OFDM optical transmitter according to an exemplary embodiment of the present invention.

A signal converter 130 controls the amplitude of each of data signals according to a position of each data signal and converts the controlled data signal into a time-domain signal. The data signals are data bits mapped to symbols at a previous stage. If the sampling rate of the following digital-to-analog converter (DAC) 160 is not significantly higher than the rate of the signal, the amplitude of an output optical carrier of a data signal is gradually decreased as a position of the data signal becomes increasingly distant from a position of a data signal located in the middle among the data signals. Hence, as a position of a data signal becomes increasingly distant from a position of a reference data signal located in the middle, the amplitude of the data signal needs to be gradually increased. As a result, optical carriers output from the DAC 160 are uniform in amplitude without an additional oversampling operation.

The signal converter 130 includes a signal amplitude controller 231 and an Inverse Fast Fourier Transform (IFFT) unit 232. The signal amplitude controller 231 adjusts the amplitude of each of carriers according to a position of each carrier. The IFFT unit 232 transforms a data signal from the signal amplitude controller 231 into a time-domain signal through Fourier transform. The output data signals are transmitted over different carriers which are orthogonal to one another.

The OFDM optical transmitter may further include a series-to-parallel converter 100, a symbol mapping unit 110, a training symbol inserter 120, a parallel-to-series converter 140, a digital-to-analog converter (DAC) 160, and an in-phase/quadrature (I/Q) modulator 170. The series-to-parallel converter 100 converts high-rate series data bits of a data signal into low-rate parallel data bits. The symbol mapping unit 110 rearranges data bits of each data signal and performs symbol-mapping on the rearranged data bits according to a predetermined modulation zo scheme. Examples of the modulation scheme may include, but are not limited to, quadrature phase-shift keying (QPSK) and quadrature amplitude modulation (QAM). The training symbol inserter 120 inserts a training symbol into each of the data signals to which data bits are mapped. The training symbol is a predetermined value which is inserted at regular intervals to prevent an error of a symbol mapped by the symbol mapping unit 110.

The parallel-to-series converter 140 converts low-rate parallel data bits from the IFFT unit 232 into high-rate series data bits. The D/A converter 160 converts the series data bits into an analog signal. In this case, a complex signal composed of real and imaginary numbers which has been generated following the IFFT unit 232 is input to the DAC 160. The I/Q modulator 170 modulates in-phase (I) and quadrature (Q) components of the analog signal from the DAC 160 into an optical signal. More specifically, the I/Q modulator 170 generates an OFDM carrier by carrying an output signal of the DAC 160 on an optical source 180. Hence, since the signal converter 130 controls the amplitude of each data signal according to the position of each data signal, the OFDM carrier generated by the I/Q modulator 170 is uniform in amplitude although the sampling rate of the DAC 160 is not significantly higher than the input rate of a signal input to the DAC 160.

The OFDM optical transmitter may further include a guard interval inserter 150. The guard interval inserter 150 inserts a guard interval into a data signal which is output from the parallel-to-series converter 140. The guard interval inserter 150 may insert a cyclic prefix to eliminate interference between each symbol and each data bit, i.e., inter-channel interference.

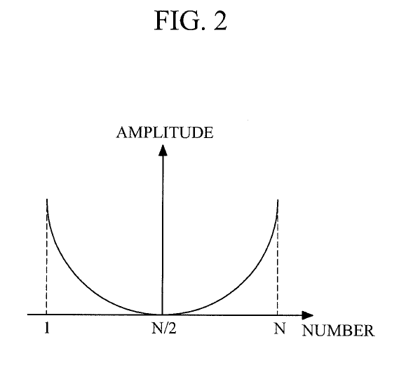

FIG. 2 is a graph illustrating the amplitude of a data signal controlled by a signal converter according to an exemplary embodiment of the present invention. In this case, the amplitude of a data signal is increased according to a quadratic function as a position of the data signal becomes increasingly distant from a position of a reference data signal which is located in zo the middle among a plurality of data signals. Alternatively, the amplitude of a data signal may be increased according to an inverse sinc function (1/sinc). Although the present embodiment describes the amplitude of a data signal which is increased according to a quadratic function or an inverse sinc function, another embodiment may also be possible only if the amplitude of a data signal is gradually increased according to any function as a position of the data signal becomes increasingly distant from a position of a reference data signal which is located in the middle among a plurality of data signals.

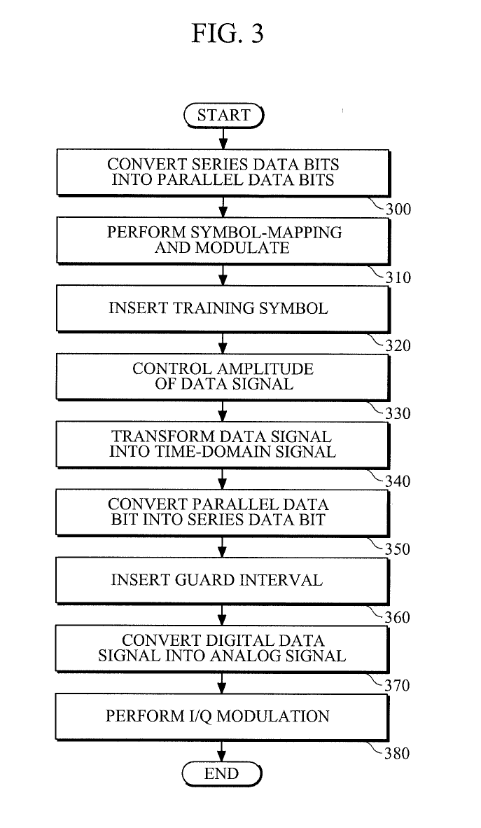

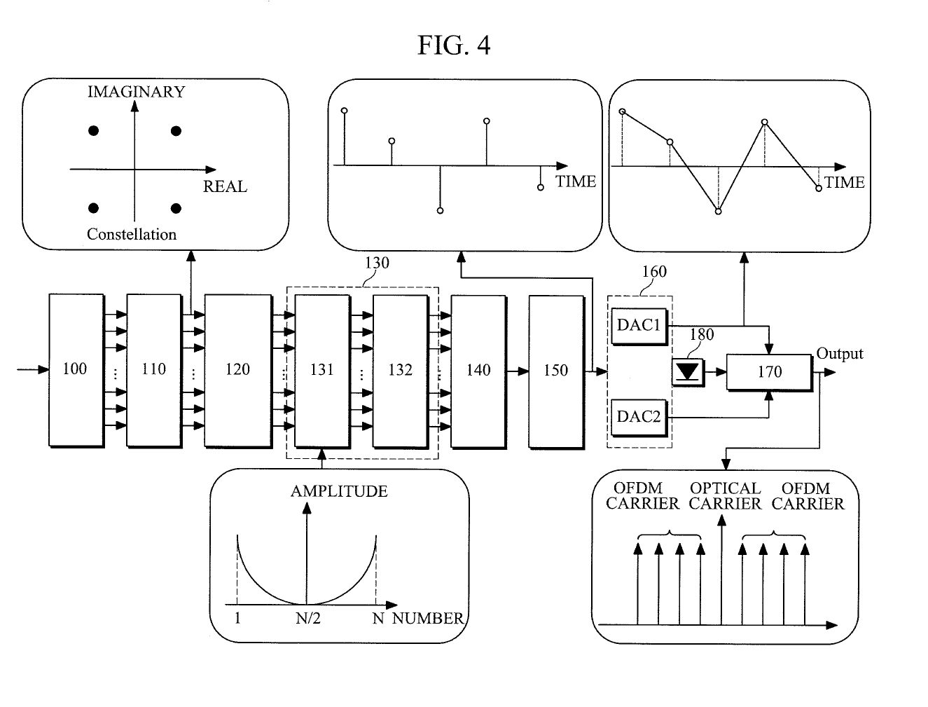

FIG. 3 is a flow chart illustrating an optical transmission method of an OFDM optical transmitter according to an exemplary embodiment of the present invention. FIG. 4 is a diagram illustrating signals of an OFDM optical transmitter at each stage in FIG. 3.

Referring to FIG. 3, in operation 300, the series-to-parallel converter 100 converts high-rate series data bits of an input data signal into low-rate parallel data bits. In operation 310, the symbol mapping unit 110 rearranges the parallel data bits and performs symbol-mapping on the rearranged parallel data bits according to a predetermined scheme. Examples of the scheme may include, but are not limited to, QPSK and QAM. The symbol-mapped data signal is represented in planar coordinates composed of real and imaginary numbers and has values of 0, π/2, π and 3π/2. In operation 320, the training symbol inserter 120 inserts a training symbol to the symbol-mapped data signal. The training symbol is a predetermined value which is used in signal equalization at a receiver at regular intervals.

In operation 330, the signal amplitude controller 231 controls the amplitude of each of data signals. Each data signal includes a symbol and a data bit, and the size of the symbol and the size of the data bit are adjusted by signal amplitude control. The amplitude of a data signal is controlled by increasing the amplitude of the data signal as a position of the data signal becomes increasingly distant from a position of a reference data signal which is located in the middle among data signals. The amplitude may be increased according to a quadratic function or an inverse sine function as the position of a data signal becomes increasingly distant from the position of the reference data signal. In operation 340, the IFFT unit 232 transforms the controlled data signal into a time-domain signal. The transformed output signals are transmitted over different carriers which are orthogonal to one another.

In operation 350, the parallel-to-series converter 140 converts low-rate parallel data bits output as a time-domain signal into high-rate series data bits. In operation 360, the guard interval inserter 150 inserts a guard interval to eliminate inter-channel interference. The guard interval inserter 150 may insert a cyclic prefix to eliminate interference between a symbol and a data bit. A signal output from the guard interval inserter 150 is represented as a time-domain signal. In operation 370, the DAC 160 converts a digital data signal with a guard interval into an analog signal. According to a related art, if a sampling rate of the DAC 160 is not higher than an input rate of a signal, OFDM carriers which are generated in the following stage are different in size from one another depending on a position of each of the OFDM carriers. However, according to an exemplary embodiment of the present invention, since the signal amplitude controller 231 controls the amplitude of the signal beforehand, the data signal is not of an analog signal as in the related art although the DAC 160 does not perform an additional oversampling operation. Hence, the size of the OFDM carrier generated in the following optical modulation operation is uniform.

In operation 380, the I/Q modulator 170 modulates in-phase (I) and quadrature (Q) components of the analog signal output from the DAC 160 into a frequency-domain signal. The I/Q modulator 170 carries the output signal of the DAC 160 on the optical source 180 to generate an OFDM carrier. It should be noted that the size of the OFDM carrier generated by the I/Q modulator 170 is uniform.

As apparent from the above description, prior to sampling high-rate data signals to be transmitted, the amplitude of each of the data signals is controlled to be different from one another according to a position of each data signal. Hence, it is possible to generate a uniform OFDM carrier without oversampling. This ensures signal-to-noise ratio (SNR) between optical OFDM carriers, resulting in high-rate data transmission.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An optical transmitter in an orthogonal frequency-division multiplexing (OFDM)-based communication system, comprising a signal converter controlling amplitude of each of data signals according to a position of each of the data signals and converting the controlled data signal into a time-domain signal.

2. The optical transmitter of claim 1, wherein the amplitude of the data signal is controlled to be increased as a position of the data signal becomes increasingly distant from a position of a reference data signal which is located in the middle among the data signals.

3. The optical transmitter of claim 1, wherein the amplitude of the data signal is controlled to be increased according to a quadratic function as a position of the data signal becomes increasingly distant from a position of a reference data signal which is located in the middle among the data signals.

4. The optical transmitter of claim 1, wherein the amplitude of the data signal is controlled to be increased according to an inverse sinc function (1/sinc) as a position of the data signal becomes increasingly distant from a position of a reference data signal which is located in the middle among the data signals.

5. The optical transmitter of claim 1, wherein the signal converter comprises:
a signal amplitude controller controlling amplitude of the data signal; and
an Inverse Fast Fourier Transform (IFFT) unit transforming the amplitude-controlled data signal into a time-domain signal.

6. The optical transmitter of claim 5, further comprising:
a series-to-parallel converter converting high-rate series data bits of a data signal into low-rate parallel data bits;
a symbol mapping unit performing symbol-mapping on the parallel data bits;
a training symbol inserter inserting a training symbol into each of the data signals where the data bits are mapped;
a parallel-to-series converter converting the low-rate parallel data bits output from the IFFT unit into high-rate series data bits;
a digital-to-analog converter converting the series data bits into an analog signal; and
an in-phase/quadrature (I/Q) modulator optically modulating in-phase (I) and quadrature (Q) components of the analog signal output from the digital-to-analog converter into a frequency-domain signal.

7. The optical transmitter of claim 6, further comprising a guard interval inserter inserting a guard interval into the data signal output from the parallel-to-series converter.

8. The optical transmitter of claim 7, wherein the guard interval inserter inserts a cyclic prefix.

9. The optical transmitter of claim 6, wherein the symbol mapping unit performs mapping according to a predetermined scheme.

10. The optical transmitter of claim 9, wherein the scheme is quadrature phase-shift keying (QPSK) or quadrature amplitude modulation (QAM).

11. An optical transmission method of an OFDM-based communication system, comprising:
controlling amplitude of each of data signals according to a position of each of the data signals; and
converting the amplitude-controlled data signal into a time-domain signal.

12. The optical transmission method of claim 11, wherein the amplitude of the data signal is controlled to be increased as a position of the data signal becomes increasingly distant from a position of a reference data signal which is located in the middle among the data signals.

13. The optical transmission method of claim 11, wherein the amplitude of the data signal is controlled to be increased according to a quadratic function as a position of the data signal becomes increasingly distant from a position of a reference data signal which is located in the middle among the data signals.

14. The optical transmission method of claim 11, wherein the amplitude of the data signal is controlled to be increased according to an inverse sine function (1/sinc) as a position of the data signal becomes increasingly distant from a position of a reference data signal which is located in the middle among the data signals.

15. The optical transmission method of claim 11, further comprising:
converting high-rate series data bits of a data signal into low-rate parallel data bits;
rearranging the parallel data bits and performing symbol-mapping and modulating on the rearranged parallel data bits;
inserting a training symbol into each of the data signals where the data bits are symbol-mapped;
converting the low-rate parallel data bits output as a time-domain signal into high-rate series data bits;
converting the series data bits as digital data into an analog signal; and
optically modulating in-phase (I) and quadrature (Q) components of the analog signal into a frequency-domain signal.

16. The optical transmission method of claim 15, wherein the symbol mapping is performed according to a predetermined scheme.

17. The optical transmission method of claim 16, wherein the scheme is quadrature phase-shift keying (QPSK) or quadrature amplitude modulation (QAM).
